(19) United States
(12) Patent Application Publication
(10) Pub. No.: US 2026/0050789 A1
(43) Pub. Date: Feb. 19, 2026

(54) CONTRASTIVE TRAINING OF NEURAL NETWORKS WITH OFF-DIAGONAL POSITIVES

(71) Applicant: Google LLC, Mountain View, CA (US)

(72) Inventors: Zhe Dong, Zürich (CH); Smriti Pramanick, New York, NY (US); Zhiying Zhang, Sammamish, WA (US); Xiaoqi Ren, Kirkland, WA (US); Rajvi Kapadia, Sunnyvale, CA (US)

(21) Appl. No.: 18/803,374

(22) Filed: Aug. 13, 2024

(51) Int. Cl. G06N 3/088

(52) U.S. Cl. CPC G06N 3/088

(57) ABSTRACT

Methods, systems, and apparatus, including computer programs encoded on a computer storage medium, for training neural networks through contrastive learning. In particular, the contrastive learning is modified to account for off-diagonal positives within batches of training pairs that are used for the training.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes techniques for training a pair of encoder neural networks through contrastive learning by accounting for off-diagonal positives during training.

The subject matter described in this specification can be implemented in particular embodiments so as to realize one or more of the following advantages.

Dense retrieval systems, e.g., dual encoder systems as described in this specification that include two jointly trained encoder neural networks, are commonly trained using contrastive learning, e.g., on an in-batch softmax loss, on multiple batches of training pairs.

Within each batch and for a given query from one of the training pairs in the batch, conventional contrastive losses treat the target item within the same training pair as the given query as a “positive” for the given query and all other target items from other training pairs as “negatives” for the given query. As a result, the contrastive loss encourages the encoder neural networks to generate embeddings that indicate a higher similarity between the given query and the target item within the same training pair than between the given query and target items from all other training pairs in the batch.

However, in many cases, there are other target items within a given batch that can be relevant to a given query, i.e., target items other than the target item within the same training pair as a given query can still be relevant to the given query. For example, when the queries represent questions and the targets represent answers, consider a batch of pairs that includes the following question, answer pairs: (“Greenland land border countries”, “Canada”), (“non-EU Schengen countries”, “Switzerland”), (“Sri Lanka former name”, “Ceylon”), (“Nicht-EU-Schengen-Länder”, “Norway”), (“Oceania largest country”, “Australia”).

The second and fourth pairs in this example, (“non-EU Schengen countries”, “Switzerland”) and (“Nicht-EU-Schengen-Länder”, “Norway”) are actually discussing similar facts. As a result, the answer “Norway” should not be treated as a negative example for the query “non-EU Schengen countries”. However, conventional contrastive losses ignore the potential for encountering such similarities between queries and targets from different pairs.

As a result, treating all other target items from other training pairs as “negatives” for the given query, as is done by conventional contrastive training, negatively impacts the training of the encoder neural networks because it provides an inaccurate training signal.

To account for this, the techniques described in this specification incorporate off-diagonal positive pairs into the training. In particular, the described techniques identify off-diagonal positives within a given batch and then “mask out” off-diagonal positives from the contrastive loss instead of treating these pairs as negatives as would be done by other contrastive training approaches. As a result, the neural networks are provided with a more accurate training signal, improving the quality of the training and resulting in more accurate retrieval after training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system.

FIG. 2 shows an example of the training of the encoder neural networks.

FIG. 3 is a flow diagram of an example process for training the encoder neural networks.

FIG. 4 is a flow diagram of an example process for identifying an off-diagonal positive pair.

FIG. 5 is a flow diagram of another example process for identifying an off-diagonal positive pair.

Like reference numbers and designations in the various drawings indicate like elements.

### DETAILED DESCRIPTION

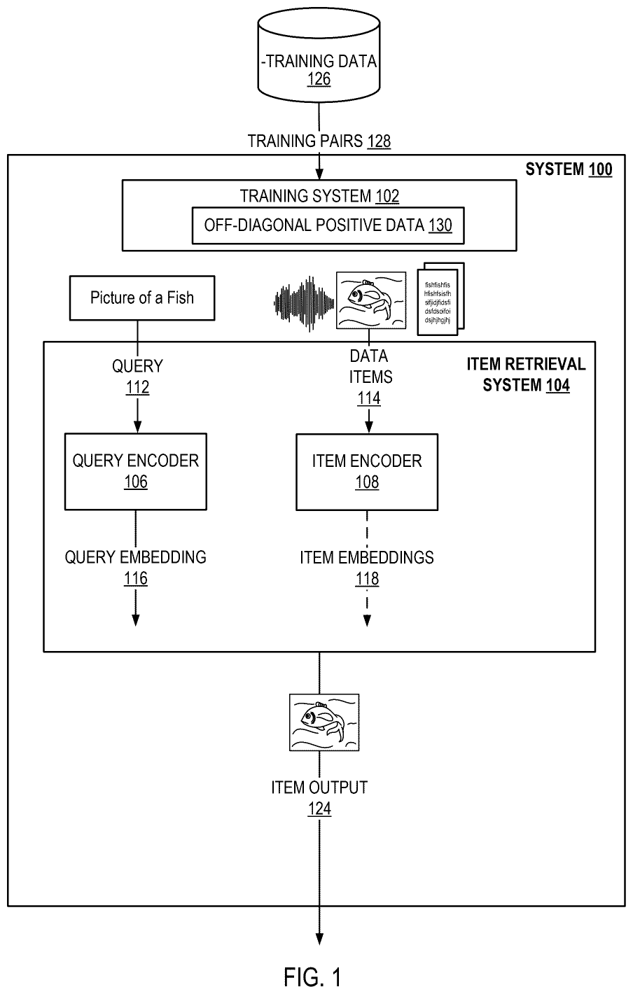

FIG. 1 shows an example system 100. The system 100 is an example of a system implemented as computer programs on one or more computers in one or more locations in which the systems, components, and techniques described below are implemented.

The system 100 is configured to retrieve a data item output that includes one or more data items in response to a query for a particular task. In particular, the system 100 is configured to retrieve the data item output (e.g., item output 124) that includes one or more data items 114 that are most relevant to the query 112.

Generally, the one or more data items 114 can be any variety of data items of a variety of different modalities, such as a text document, an image, a video, an audio signal, or a multi-modal data item that includes data of two or more modalities, e.g., two or more of text, image, audio, or video.

Similarly, the query 112 can be any of a variety of data of any of a variety of different modalities, e.g., a text query, an image query, a video query, an audio query, or a multi-modal query that includes data of two or more modalities, e.g., two or more of text, image, audio, or video. In some cases, the query 112 and the data items 114 are the same modality while, in other cases, the query 112 and the data items 114 are different modalities.

The system 100 includes a training system 102 and an item retrieval system 104.

After training, the item retrieval system 104 is configured to generate the item output 124 in response to the query 112.

The item retrieval system 104 includes a query encoder neural network 106 configured to generate a query embedding 116 by processing the query 112 and an item encoder neural network 108 configured to generate an item embedding 118 by processing each of the data items 114.

In particular, the system 104 uses the item encoder 108 to generate multiple item embeddings 118 each corresponding to a respective one of the target data items 114. For example, the system 104 can use the item encoder 108 to generate the item embeddings 118 offline after training is completed and before new queries are processed by the system 104.

The item embedding 118 can be an ordered collection of numeric values (e.g., a vector or matrix of floating point or other numeric values that represents the target data item 114).

Each item embedding 118 is generally an embedding in a particular embedding space. An “embedding space” is the space of embeddings having a specified dimensionality, e.g., the space of vectors that have a specified number of entries.

The item encoder 108 can be any appropriate neural network that can map a data item of a particular type to an embedding. For example, the item encoder 108 can be a Transformer, a convolutional neural network, a vision Transformer, or a recurrent neural network.

The system 104 stores the item embeddings 118 in a data structure that is configured to allow the item embeddings 118 to be searched. For example, the data structure can be an index.

The system can then receive the query 112. In particular, the query 112 can be a new query submitted by a user of the system. For example, a user can submit the query 112 by inputting the query into a user interface.

In some examples, the query can be a query for a general retrieval task. For example, the query can be “Picture of a Fish.”

In some other examples, the query can be a query for a relatively specialized retrieval task of a particular relevant output, such as whether the data item is positive or negative or the length/size of the data item. For example, the query can be “Positive Review of Donuts” or “Long Description of Donuts.”

The system can generate a query embedding 116 by processing the query 112 using the query encoder 106.

The query embedding 116 can be an ordered collection of numeric values (e.g., a vector or matrix of floating point or other numeric values that represents the query 112) that has the same dimensionality as the item embeddings, i.e., that is in the same embedding space as the item embeddings.

The query encoder 106 can be any appropriate neural network that can map the query to an embedding. For example, the query encoder 106 can be a Transformer, a convolutional neural network, a vision Transformer, or a recurrent neural network.

As will be described below, the query encoder 106 can be pre-trained jointly with the item encoder 108 (e.g., through contrastive learning).

Based on the query embedding 116, the system 100 can select one or more item embeddings 118 that correspond to one or more relevant data items 114.

In particular, the system can perform a search to identify one or more item embeddings 118 that are closest to the query embedding 116 according to a similarity measure, e.g., cosine similarity, Euclidean distance, and so on. For example, the system can perform a k-nearest neighbor search or an approximate k-nearest neighbor search of the item embeddings 118 to find the item embedding 118 that is closest to the query embedding 116.

The system can then generate (e.g., retrieve) the data output 124 including the one or more corresponding relevant data items 114 for the particular task. For example, the system can provide the data output 124 for presentation to a user or to another system that submitted the query.

Prior to using the encoder neural networks to generate data outputs, the training system 102 trains the encoder neural networks through contrastive learning.

More specifically, the training system trains the neural networks using training pairs 128 from a set of training data 126.

Each training pair 128 includes a training query and a training target data item, i.e., a target data item that has been determined to be relevant to the training query.

Unlike conventional systems, the training system 102 maintains off-diagonal positive data 130 and uses the data 130 to modify the contrastive loss function that the system 102 uses for the training.

The off-diagonal positive data 130 identifies “off-diagonal” positive pairs within the training data 126. Each off-diagonal positive includes a training query from one of the training pairs 128 and a target data item from a different training pair 128. That is, each off-diagonal positive pair includes a training query input and a training target data item from a different training pair than the training query input. Generally, for any given off-diagonal positive pair, the target data item in the off-diagonal positive pair has been determined, e.g., by the system 102 or by a different system, to be relevant to the query in the off-diagonal positive pair despite not being in the same training pair 128 as the query.

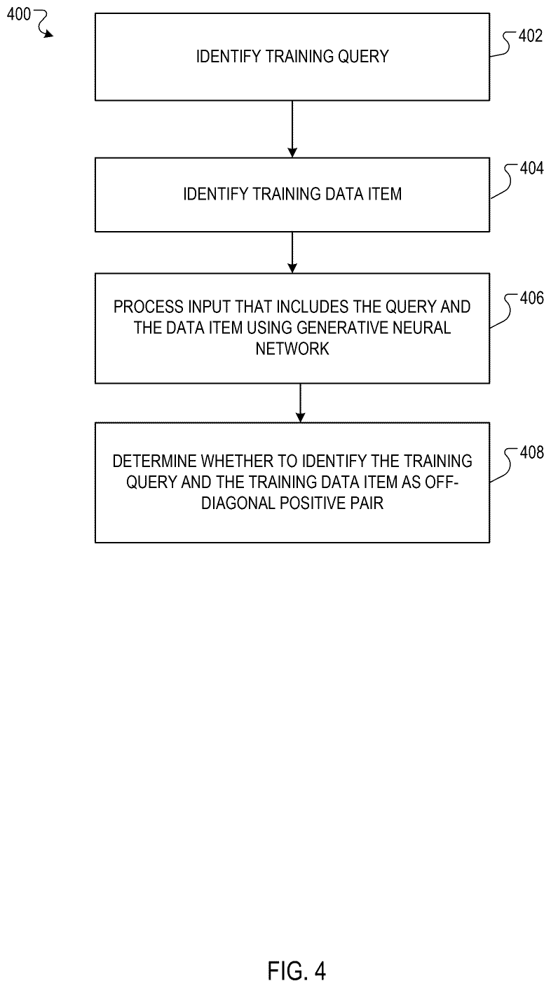

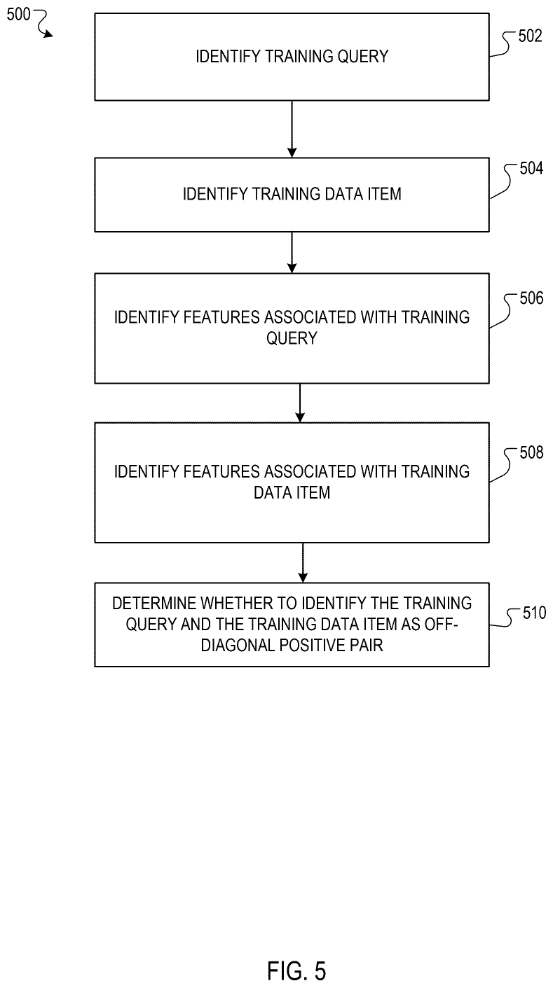

In some implementations, the system 102 can generate the off-diagonal positive data 130 off-line, e.g., prior to beginning the training of the neural networks. Example techniques for generating off-diagonal positive data 130 are described below with reference to FIGS. 4 and 5.

More specifically, the system 102 performs the training of the neural networks by performing multiple iterations of a training process.

At each iteration of the training process, the system 102 obtains a batch of training pairs 128. For example, the system 102 can sample the batch from the training data 126.

The system 102 then uses the batch of training pairs 128 to update the parameters of the neural networks using gradients of a contrastive loss function.

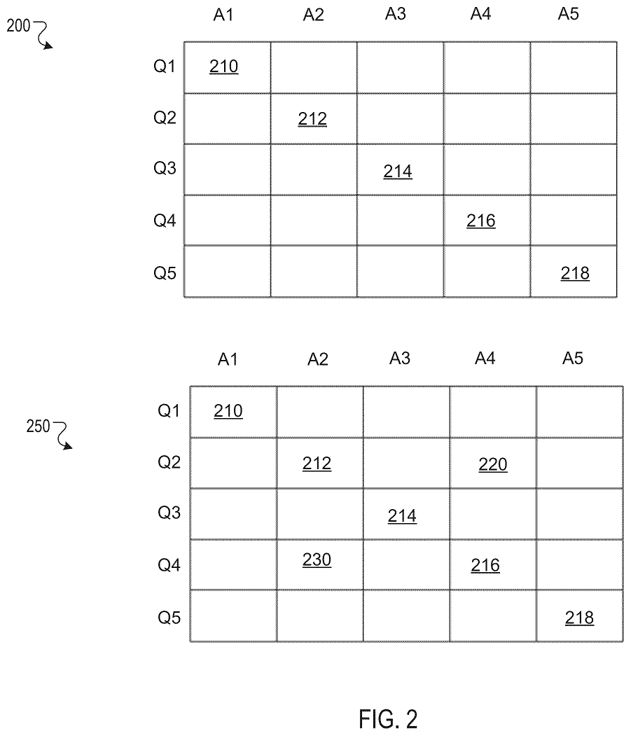

FIG. 2 shows an example of training on a batch of training pairs using a contrastive loss function.

In particular, FIG. 2 shows an example 200 of a conventional training process and an example 250 of training using off-diagonal positives.

In the examples 200 and 250 shown in FIG. 2, the batch of training pairs includes five training pairs (Q1, A1), (Q2, A2), (Q3, A3), (Q4, A4), and (Q5, A5) that each include a training query Q and a training target data item A.

In a conventional training process, the system treats the diagonal entries 210, 212, 214, 216, and 218 of a matrix that has rows corresponding to the queries Q as positives and columns corresponding to the data items A as positives while treating every off-diagonal entry of the matrix as a negative. Generally, the contrastive loss encourages the positives to have similarity scores that are more similar to one another than the negatives.

In the example 250, however, the system has identified two entries 220 and 230 as corresponding to respective off-diagonal positive pairs, i.e., off-diagonal positive pairs (Q4, A2) and (Q2, A4). That is, the system has determined that A2 is relevant to Q4 despite not being in the same training and that A4 is relevant to Q2 despite not being in the same training pair.

That is, because the batch of training pairs is sampled randomly, there is a possibility that any given target item can be relevant to queries from other pairs in the given batch (in addition to being relevant to the query in the same pair as the given target item).

Because these off-diagonal positive pairs indicate a degree of relevance between the corresponding query and data item, rather than treating the entries 220 and 230 as negatives, the system “masks out” these entries from the contrastive loss function. As a result, the contrastive loss function does not encourage these pairs to have similarity scores that indicate dissimilarity even though the query and data item in each of these pairs are from different training pairs.

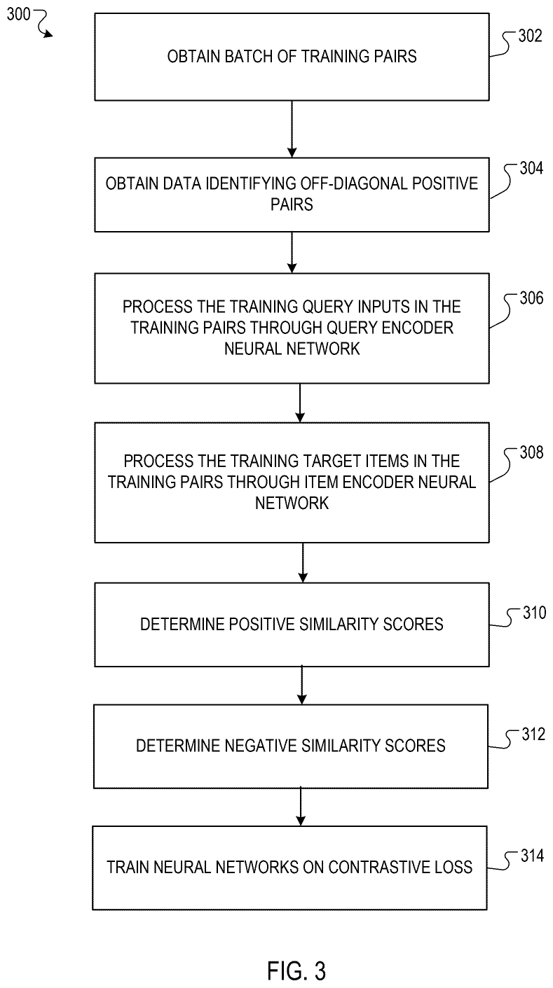

Performing training is described in more detail below with reference to FIG. 3.

FIG. 3 is a flow diagram of an example process 300 for training an item encoder neural network and a query encoder neural network. For convenience, the process 300 will be described as being performed by a system of one or more computers in one or more locations. For example, a training system, e.g., the training system 102 of FIG. 1, appropriately configured in accordance with this specification, can perform the process 300.

The system can repeatedly perform the process 300 on different batches of training pairs to train the two encoder neural networks jointly.

The system obtains a batch of training pairs, each training pair including a training query input and a training target item (step 302).

The system also obtains data identifying, as off-diagonal positive pairs, one or more pairs that each include a training query input and a training target data item from a different training pair in the batch than the training query input (step 304).

In some implementations, the system processes the training data set offline to identify off-diagonal positive pairs that occur within the training data set.

In some other implementations, the system analyzes the queries and data items in the training data items in the batch after the batch is obtained in order to identify any off-diagonal positive pairs that occur.

Example techniques for determining whether a given training query input and a given training target data item from a different training pair than the given training query input should be identified as an off-diagonal positive pair are described below with reference to FIGS. 4 and 5.

The system processes the training query inputs in the training pairs through the query encoder neural network in accordance with current values of the query encoder neural network parameters to generate a respective query embedding of each training query input (step 306).

The system processes each training target data item in each training pair through the item encoder neural network in accordance with current values of the item encoder neural network parameters to generate a respective training query input embedding of each training target data item (step 308).

The system determines a plurality of positive similarity scores (step 310). Generally, each positive similarity score corresponds to one of the training pairs and measures a similarity between the embedding for the training query in the training pair and the embedding of the training target item in the training pair. In other words, the system can generate a respective positive similarity score for each of the training pairs that measures the similarity between the embedding for the training query in the training pair and the embedding of the training target item in the training pair. For example, the positive similarity score can be a dot product or cosine similarity between the embedding for the training query in the training pair and the embedding of the training target item in the training pair.

The system determines a plurality of negative similarity scores (step 312).

Each negative similarity score corresponds to a respective first training query and a respective other second target item that is (i) not in the same training pair as the respective first training query and (ii) not in a same off-diagonal positive pair as the first training query. Each negative similarity score measures a similarity between the first embedding of the respective first training query and the second embedding of the respective second target item.

For example, the negative similarity score can be a dot product or cosine similarity between the embedding for the first training query and the embedding of the respective other second target item.

Advantageously, the system does not include, in the plurality of negative similarity scores, a similarity score for any of the off-diagonal positive pairs even though each of these pairs include a query and a data item that are from two different training pairs. For example, the system can refrain from computing similarity scores for off-diagonal positive pairs or can discard the similarity scores after computing them.

The system trains the query encoder neural network and the target encoder neural network on a contrastive loss function applied to the (i) positive similarity scores and (ii) the negative similarity scores (step 314). That is, the system “masks out” the off-diagonal positive pairs from the contrastive loss function and does not include a similarity score for any of the off-diagonal positive pairs in the contrastive loss function.

Generally, the contrastive loss function encourages the positive similarity scores to reflect a higher similarity than the negative similarity scores.

As one example, the contrastive loss can be represented as follows:

$${L}_{c} = {\sum }_{i ∈ B} \frac{{e}^{sim ( {Q}_{i} , {A}_{i} ) / τ}}{{\sum }_{j ∈ B , ∉ ODP} {e}^{sim ( {Q}_{i} , {A}_{j} ) / τ}} ,$$

where B is the batch of training examples, ODP is the set of off-diagonal positive pairs, τ is a softmax temperature that can be received as input by the system or determined through a hyperparameter search, and sim (Q,A) is a similarity score between a query Q and a target data item A, i.e., a similarity score between the embedding of the query Q and the embedding of the target data item A.

More generally, the system can use any appropriate contrastive loss that measures similarities between positive and negative pairs, but modified to “mask out” similarity scores for off-diagonal positive pairs. Examples of contrastive losses that can be adapted in this manner include the CLIP loss and the SimCLR loss.

The system can train the neural networks using gradients of the contrastive loss. That is, the system can compute gradients of the contrastive loss with respect to the parameters of the query encoder and the item encoder and then apply an optimizer, e.g., the stochastic gradient descent optimizer, the Adam optimizer, the AdamW optimizer, and so on, to the gradients to update the parameters of the two neural networks.

Optionally, the loss function can also include one or more additional terms, e.g., regularization terms, in addition to a contrastive loss term as described above.

After training the neural networks, the system or another inference system can use at least a portion of the query encoder neural network, the target item encoder neural network, or both to perform a downstream task.

For example, the system or the inference system can use both neural networks to perform an information retrieval task as described above, i.e., to retrieve target data items that are relevant to received queries.

As another example, the system can fine-tune a task neural network that includes at least a portion of the query encoder neural network, the target encoder neural network, or both on training data for the downstream task. For example, the task neural network can include the query encoder neural network and one or more additional layers that generate the output for the downstream task. As another example, the system can further fine-tune the query encoder, the target encoder, or both before using the neural networks to perform the retrieval task.

Generally, examples of downstream tasks can include language modeling, image captioning, visual question answering, open vocabulary recognition, cross-modal retrieval, and so on.

FIG. 4 is a flow diagram of an example process 400 for determining whether to identify a query and a data item as an off-diagonal positive pair. For convenience, the process 400 will be described as being performed by a system. For example, a system, e.g., the training system 102 of FIG. 1, appropriately configured in accordance with this specification, can perform the process 400.

The system obtains data identifying a training query from a first training pair in the training data (step 402).

The system obtains data identifying a training data item from a second, different training pair in the training data (step 404).

For example, as described above, the system can perform the process 400 offline to identify off-diagonal positive pairs. In this example, the system can perform a respective instance of the process 400 for each possible query-data item pair, where the query and the data item are from different training pairs within the training data.

As another example, as described above, the system can perform the process 400 each time a batch is sampled. In this example, the system can perform a respective instance of the process 400 for each possible query-data item pair from among the queries and data items in the pairs in the batch, where the query and the data item are from different training pairs within the batch.

The system processes an input that includes the training query and the training data item using a similarity prediction neural network, e.g., a generative neural network, to generate an output that indicates a relevance of the training data item to the training query (step 406). For example, the generative neural network can be a language model neural network, e.g., a large language model neural network (LLM), or a multi-modal generative neural network, e.g., a visual language model neural network (VLM), a large multi-modal language model neural network, and so on.

Optionally, the input can also include a “prompt” that instructs the generative neural network to evaluate the relevance of the training data item to the training query. For example, the prompt can be a natural language instruction, a few-shot prompt, or both.

The output that indicates the relevance can be a natural language output, e.g., “yes” or “no,” or a relevance score, e.g., a score assigned by the generative neural network to a pre-determined output that indicates relevance.

The system determines, from the output, whether to identify the training query and the training data item as an off-diagonal positive pair (step 408). For example, when the output that indicates the relevance is a natural language output, the system can identify the training query and the training data item as an off-diagonal positive pair when the output is a pre-determined natural language output that indicates relevance. As another example, when the output is a relevance score, the system can identify the training query and the training data item as an off-diagonal positive pair when the relevance score exceeds a threshold value.

FIG. 5 is a flow diagram of another example process 500 for determining whether to identify a query and a data item as an off-diagonal positive pair. For convenience, the process 500 will be described as being performed by a system. For example, a system, e.g., the training system 102 of FIG. 1, appropriately configured in accordance with this specification, can perform the process 500.

The system obtains data identifying a training query from a first training pair in the training data (step 502).

The system obtains data identifying a training data item from a second, different training pair in the training data (step 504).

For example, as described above, the system can perform the process 500 offline to identify off-diagonal positive pairs. In this example, the system can perform a respective instance of the process 500 for each possible query-data item pair, where the query and the data item are from different training pairs within the training data.

As another example, as described above, the system can perform the process 500 each time a batch is sampled. In this example, the system can perform a respective instance of the process 500 for each possible query-data item pair from among the queries and data items in the pairs in the batch, where the query and the data item are from different training pairs within the batch.

The system identifies a set of features that are associated with the training query (step 506). For example, the features can be features that describe the training query or otherwise characterize properties of the training query and can have been generated by another system. For example, when the training queries are text, the features can have been generated by a natural language processing system. As another example, when the training queries are images or videos, the features can have been generated by a computer vision system, e.g., an image captioning or object detection system. As another particular example, when the queries are queries that have been submitted to a search engine, the features can have been generated by the search engine system, e.g., based on the informational need of users that have submitted the queries.

The system identifies a set of features that are associated with the target data item (step 508). For example, the features can be features that describe the target data item or otherwise characterize properties of the target data item and can have been generated by another system. For example, when the target data items are text, the features can have been generated by a natural language processing system. As another example, when the target data items are images or videos, the features can have been generated by a computer vision system, e.g., an image captioning or object detection system. As another particular example, when the queries are queries that have been submitted to a search engine, the features for target data items can have been generated by the search engine system, e.g., based on which training queries have resulted in users interacting with search results identifying the data item.

The system determines, from the features associated with the query and the target data item, whether to identify the training query and the training data item as an off-diagonal positive pair (step 510).

For example, the system can identify the training query and the training data item as an off-diagonal positive pair when the features associated with the training query and the features associated with the training data item have a threshold amount of overlap, i.e., more than a threshold number of features are associated with both the training query and the training data item.

As another example, the system can process the features using the similarity evaluation neural network as described above to determine whether the sets of features indicate a similarity between the corresponding query and data item.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible storage medium, which may be non-transitory, for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training (i) a query encoder neural network having query encoder neural network parameters and configured to process a query input to generate a query embedding of the query input in an embedding space and (ii) an item encoder neural network having item encoder neural network parameters and configured to process a target item to generate a target item embedding of the target item in the embedding space, the method comprising, at each of a plurality of training steps:
obtaining a batch of training pairs, each training pair including a training query input and a training target item;
obtaining data identifying, as off-diagonal positive pairs, one or more pairs that each include (i) a respective training query input and (ii) a training target item from a different training pair in the batch than the training query input;
processing the training query inputs in the training pairs through the query encoder neural network in accordance with current values of the query encoder neural network parameters to generate a respective query embedding of each training query input;
processing the training target items in the training pairs through the item encoder neural network in accordance with current values of the item encoder neural network parameters to generate a respective training target item embedding of each training target item;
determining a plurality of positive similarity scores, each positive similarity score corresponding to one of the training pairs and measuring a similarity between the respective query embedding of the training query input in the training pair and the respective training target item embedding of the training target item in the training pair;
determining a plurality of negative similarity scores, each negative similarity score corresponding to a respective training query input and a respective training target item that is (i) not in a same training pair as the respective training query input and (ii) not in a same off-diagonal positive pair as the respective training query input and measuring a similarity between the respective query embedding of the corresponding training query input and the respective training target item embedding of the corresponding training target item; and
training the query encoder neural network and the target item encoder neural network on a contrastive loss function applied to the (i) positive similarity scores and (ii) the negative similarity scores.

2. The method of claim 1, wherein the contrastive loss function does not depend on similarity scores corresponding to any of the off-diagonal positive pairs.

3. The method of claim 1, further comprising:
generating the data identifying the off-diagonal positive pairs.

4. The method of claim 3, wherein generating the data comprises:
for each of a plurality of pairs that each include a training query input and a target item from a different training pair than the training query input:
processing the training query input and the training target item in the pair using a similarity prediction neural network to generate a similarity output that indicates a similarity between the training query input and the training target item in the pair; and
determining whether to designate the pair as an off-diagonal positive pair based on the similarity output.

5. The method of claim 4, wherein the similarity prediction neural network is a generative neural network and wherein processing the training query input and the training target item in the pair using the similarity prediction neural network comprises processing the training query input and the training target item in the pair and a prompt that causes the generative neural network to generate the similarity output.

6. The method of claim 3, wherein generating the data identifying the off-diagonal pairs comprises generating the data prior to performing the plurality of training steps.

7. The method of claim 1, wherein the query encoder neural network is an image encoder neural network and the query input is an input image.

8. The method of claim 1, wherein the query encoder neural network is a text encoder neural network and the query input is an input text segment.

9. The method of claim 1, wherein the target encoder neural network is a text encoder neural network and the target item is an input text segment.

10. The method of claim 1, wherein the positive and negative similarity scores measure a cosine similarity.

11. The method of claim 1, wherein the method further comprises using at least a portion of the query encoder neural network, the target item encoder neural network, or both to perform a downstream task.

12. The method of claim 1, wherein the method further comprises fine-tuning a task neural network that includes at least a portion of the query encoder neural network, the target encoder neural network, or both on training data for the downstream task.

13. The method of claim 1, wherein, for each off-diagonal positive pair, the target item in the off-diagonal positive pair has been identified as being relevant to the query in the off-diagonal positive pair.

14. The method of claim 1, wherein the contrastive loss function comprises a contrastive loss term L_{c} that is represented as:
$${L}_{c} = {\sum }_{i ∈ B} \frac{{e}^{sim ( {Q}_{i} , {A}_{i} ) / τ}}{{\sum }_{j ∈ B , ∉ ODP} {e}^{sim ( {Q}_{i} , {A}_{j} ) / τ}} ,$$
where B is the batch of training examples, ODP is the set of off-diagonal positive pairs, and τ is a softmax temperature.

15. One or more non-transitory computer storage media storing instructions that when executed by one or more computers cause the one or more computers to perform operations for training (i) a query encoder neural network having query encoder neural network parameters and configured to process a query input to generate a query embedding of the query input in an embedding space and (ii) an item encoder neural network having item encoder neural network parameters and configured to process a target item to generate a target item embedding of the target item in the embedding space, the operations comprising, at each of a plurality of training steps:
obtaining a batch of training pairs, each training pair including a training query input and a training target item;
obtaining data identifying, as off-diagonal positive pairs, one or more pairs that each include (i) a respective training query input and (ii) a training target item from a different training pair in the batch than the training query input;
processing the training query inputs in the training pairs through the query encoder neural network in accordance with current values of the query encoder neural network parameters to generate a respective query embedding of each training query input;
processing the training target items in the training pairs through the item encoder neural network in accordance with current values of the item encoder neural network parameters to generate a respective training target item embedding of each training target item;
determining a plurality of positive similarity scores, each positive similarity score corresponding to one of the training pairs and measuring a similarity between the respective query embedding of the training query input in the training pair and the respective training target item embedding of the training target item in the training pair;
determining a plurality of negative similarity scores, each negative similarity score corresponding to a respective training query input and a respective training target item that is (i) not in a same training pair as the respective training query input and (ii) not in a same off-diagonal positive pair as the respective training query input and measuring a similarity between the respective query embedding of the corresponding training query input and the respective training target item embedding of the corresponding training target item; and
training the query encoder neural network and the target item encoder neural network on a contrastive loss function applied to the (i) positive similarity scores and (ii) the negative similarity scores.

16. A system comprising:
one or more computers; and
one or more storage devices communicatively coupled to the one or more computers, wherein the one or more storage devices store instructions that, when executed by the one or more computers, cause the one or more computers to perform operations for training (i) a query encoder neural network having query encoder neural network parameters and configured to process a query input to generate a query embedding of the query input in an embedding space and (ii) an item encoder neural network having item encoder neural network parameters and configured to process a target item to generate a target item embedding of the target item in the embedding space, the operations comprising, at each of a plurality of training steps:
obtaining a batch of training pairs, each training pair including a training query input and a training target item;
obtaining data identifying, as off-diagonal positive pairs, one or more pairs that each include (i) a respective training query input and (ii) a training target item from a different training pair in the batch than the training query input;
processing the training query inputs in the training pairs through the query encoder neural network in accordance with current values of the query encoder neural network parameters to generate a respective query embedding of each training query input;
processing the training target items in the training pairs through the item encoder neural network in accordance with current values of the item encoder neural network parameters to generate a respective training target item embedding of each training target item;
determining a plurality of positive similarity scores, each positive similarity score corresponding to one of the training pairs and measuring a similarity between the respective query embedding of the training query input in the training pair and the respective training target item embedding of the training target item in the training pair;
determining a plurality of negative similarity scores, each negative similarity score corresponding to a respective training query input and a respective training target item that is (i) not in a same training pair as the respective training query input and (ii) not in a same off-diagonal positive pair as the respective training query input and measuring a similarity between the respective query embedding of the corresponding training query input and the respective training target item embedding of the corresponding training target item; and
training the query encoder neural network and the target item encoder neural network on a contrastive loss function applied to the (i) positive similarity scores and (ii) the negative similarity scores.

17. The system of claim 16, wherein the contrastive loss function does not depend on similarity scores corresponding to any of the off-diagonal positive pairs.

18. The system of claim 17, the operations further comprising:
generating the data identifying the off-diagonal positive pairs.

19. The system of claim 18, wherein generating the data comprises:
for each of a plurality of pairs that each include a training query input and a target item from a different training pair than the training query input:
processing the training query input and the training target item in the pair using a similarity prediction neural network to generate a similarity output that indicates a similarity between the training query input and the training target item in the pair; and
determining whether to designate the pair as an off-diagonal positive pair based on the similarity output.

20. The system of claim 16, wherein, for each off-diagonal positive pair, the target item in the off-diagonal positive pair has been identified as being relevant to the query in the off-diagonal positive pair.
